(19) United States
(12) Patent Application Publication
(10) Pub. No.: US 2016/0318615 A1
(43) Pub. Date: Nov. 3, 2016

(54) AUTONOMOUS SAFETY AND RECOVERY SYSTEM FOR UNMANNED AERIAL VEHICLES

(71) Applicant: SkyFallX, LLC, Quebec, TN (US)

(72) Inventor: Michael Andrew Pick, Quebeck, TN (US)

(21) Appl. No.: 15/140,718

(22) Filed: Apr. 28, 2016

Related U.S. Application Data
(60) Provisional application No. 62/153,942, filed on Apr. 28, 2015.
(60) Provisional application No. 62/215,291, filed on Sep. 8, 2015.

(51) Int. Cl. B64D 17/54; B64C 25/32; B64C 39/02; B64D 17/80

(52) U.S. Cl. CPC B64D 17/54; B64D 17/80; B64C 25/32; B64C 39/02; B64C 2201/185; B64C 2201/027

(57) ABSTRACT

A safety and recovery system for an unmanned aerial vehicle including a parachute holder mountable to the aerial vehicle. A parachute is disposed in the parachute holder. An actuator is engaged with the parachute holder. A flight sensor is in communication with the actuator, the flight sensor programmed to detect one or more predetermined emergency flight conditions, and transmit an emergency signal when the flight sensor detects one of the predetermined emergency flight conditions. The actuator deploys the parachute from the parachute holder when the actuator receives the emergency signal from the flight sensor. Autonomous deployment of the parachute can help minimize damage to the aerial vehicle, equipment on the aerial vehicle, or objects or persons beneath the aerial vehicle, in the event of an emergency.

### CROSS-REFERENCES TO RELATED APPLICATIONS

This application claims priority to U.S. Patent Application Ser. No. 62/153,942 filed Apr. 28, 2015 entitled Autonomous Safety and Recovery System for Multicopters, and to U.S. Patent Application Ser. No. 62/215,291 filed Sep. 8, 2015 entitled Autonomous Safety and Recovery System for Multicopters which are both herein incorporated by reference in their entirety.

A portion of the disclosure of this patent document contains material that is subject to copyright protection. The copyright owner has no objection to the reproduction of the patent document or the patent disclosure, as it appears in the U.S. Patent and Trademark Office patent file or records, but otherwise reserves all copyright rights whatsoever.

### STATEMENT REGARDING FEDERALLY SPONSORED RESEARCH OR DEVELOPMENT

Not Applicable

### REFERENCE TO SEQUENCE LISTING OR COMPUTER PROGRAM LISTING APPENDIX

Not Applicable

### BACKGROUND OF THE INVENTION

The present disclosure relates generally to the safety and recovery of falling unmanned aerial vehicles such as multi-copters or drones.

More particularly, the present disclosure relates to parachutes or other fall safety devices for such aerial vehicles. Unmanned drones and multi-copters have become increasing popular in recent years for recreational applications. Unmanned vehicles are also being increasingly used for aerial photography applications where the vehicles are equipped with cameras that can take aerial photos for various purposes. The aerial vehicles themselves can be quite costly, and in photography applications, the camera equipment placed on the vehicles can also be very expensive.

During flight there is the potential that one or more elements of the aerial vehicles can fail, including but not limited to the motors, batteries, propellers or ESC (electronic speed controllers). The result of such an equipment failure can result in immediate flight loss, which sends the aerial vehicle into a free fall towards the ground or another object (e.g., a tree, building, person etc.). Impact with the ground or another object can cause significant and undesirable damage to the vehicle itself or to expensive equipment such as one or more high definition cameras mounted on the vehicle.

Some conventional solutions to overcome this problem include a parachute system remotely activated via a radio transmitter whenever the user observes an emergency condition or free fall of the vehicle. Such parachute systems are considerably expensive, in some cases being more expensive than the vehicle they are meant to protect. Additionally, the system is entirely controlled by the operator, and as such, susceptible to human error. If the operator becomes distracted and the vehicle experiences flight loss, the operator may not realize the emergency state of the vehicle until after the vehicle has already hit the ground or another object and has potentially been damaged. Additionally, because many remotely activated systems are based on radio frequency, if the vehicle is flown out of the radio transmitter's range, such systems will not activate even if the operator is aware of the failure and tries to actuate the parachute.

What is needed then are improvements in safety systems for unmanned aerial vehicles.

### BRIEF SUMMARY

This Brief Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

One aspect of the disclosure is a safety and recovery system for an unmanned aerial vehicle including a parachute holder mountable to the aerial vehicle. A parachute can be disposed in the parachute holder. An actuator can be engaged with the parachute holder. A flight sensor can be in communication with the actuator, the flight sensor programmed to detect one or more predetermined emergency flight conditions. The flight sensor can transmit an emergency signal when the flight sensor detects one of the predetermined emergency flight conditions, wherein the actuator deploys the parachute from the parachute holder when the actuator receives the emergency signal from the flight sensor.

The deployment of the parachute out of the parachute holder during an emergency in flight condition can help slow the fall of the aerial vehicle toward the ground and help prevent any damage to the aerial vehicle or other equipment positioned on the vehicle as the aerial vehicle reaches the ground. Prevention of damage to the vehicle or other equipment can help save repair or replacement costs, which can be considerable.

Another aspect of the present disclosure is a safety and recovery system for an unmanned aerial vehicle including a parachute canister mountable to the aerial vehicle, the parachute canister including a cover movable between an open position and a closed position. A parachute can be disposed in the parachute canister when the cover is in the closed position, the parachute deployable out of the parachute canister as the cover moves from the closed position to the open position. In some embodiments, the parachute can be biased to deploy out of the canister as the cover moves from the closed position to the open position. An actuator can engage the cover, and the actuator can be oriented to retain the cover in the closed position when the actuator is engaged with the cover. A flight sensor can be in communication with the actuator, and the flight sensor can be programmed to detect one or more predetermined emergency flight conditions, and transmit an emergency signal when the flight sensor detects one of the predetermined emergency flight conditions, the actuator disengaging from the cover when the actuator receives the emergency signal from the flight sensor such that the cover is allowed to move to the open position and the parachute is deployed from the parachute canister.

One objective of the present disclosure is to slow the fall of an aerial vehicle in freefall during an in-flight emergency.

Another objective of the present disclosure is to provide an autonomous safety system that helps reduce the input needed from an operator to actuate the system.

Numerous other objects, advantages, and features of the present disclosure will be readily apparent to those of skill in the art upon a review of the following drawings and description of several embodiments of the present disclosure.

### BRIEF DESCRIPTION OF THE DRAWINGS

FIG. 1 is a perspective view of an aerial vehicle including an embodiment of a safety and recovery system of the present disclosure.

FIG. 2 is a detailed view of the system of FIG. 1 with an actuator engaged with a cover in a closed position.

FIG. 3 is a partial cross section view of a parachute canister of FIG. 2.

FIG. 4 is a top perspective view of the parachute canister of FIG. 2 with the actuator disengaged from the cover.

FIG. 5 is a top perspective view showing the parachute canister of FIG. 4 when the cover is moved to an opened position.

FIG. 6 is a side view of the parachute canister of FIG. 5 with the parachute fully deployed.

FIG. 7 is a perspective view of the system of FIG. 1 fully deployed and slowing the decent of an aerial vehicle.

FIG. 8 is a top perspective view of an embodiment of a base platform on which the parachute canister of FIG. 1 can be mounted.

FIG. 9 is a top perspective view showing the canister of FIG. 1 mounted on the base platform of FIG. 8.

FIG. 10 is a front perspective view of another embodiment of an autonomous safety and recovery system of the present disclosure including a base platform which is coupled to opposing sides of an aerial vehicle such that the system is positioned generally over the center of the aerial vehicle.

FIG. 11 is a top perspective view of another embodiment of an autonomous safety and recovery system of the present disclosure being mounted on a different type of aerial vehicle from the one shown in FIG. 1.

FIG. 12 a detailed view showing the system of FIG. 11 being mounted or clamped to a landing skid of an aerial vehicle.

FIG. 13 is a top perspective view of the parachute canister of FIG. 2 showing a retention rod aperture in an upper end of the parachute canister.

FIG. 14 is a partial cross section and partial schematic view of another embodiment of an autonomous safety and recovery system including one or more color changing light sources.

FIG. 15 is a schematic view showing the communication lines between a flight sensor, a separate secondary independent power source, an audible alarm system, an actuator, and a light source of an autonomous safety and recovery system of the present disclosure.

FIG. 16 is a logic diagram for an embodiment of a feedback verification system of a flight sensor of the present disclosure.

### DETAILED DESCRIPTION

While the making and using of various embodiments of the present invention are discussed in detail below, it should be appreciated that the present invention provides many applicable inventive concepts that are embodied in a wide variety of specific contexts. The specific embodiments discussed herein are merely illustrative of specific ways to make and use the invention and do not delimit the scope of the invention. Those of ordinary skill in the art will recognize numerous equivalents to the specific apparatus and methods described herein. Such equivalents are considered to be within the scope of this invention and are covered by the claims.

In the drawings, not all reference numbers are included in each drawing, for the sake of clarity. In addition, positional terms such as “upper,” “lower,” “side,” “top,” “bottom,” etc. refer to the apparatus when in the orientation shown in the drawing, or as otherwise described. A person of skill in the art will recognize that the apparatus can assume different orientations when in use.

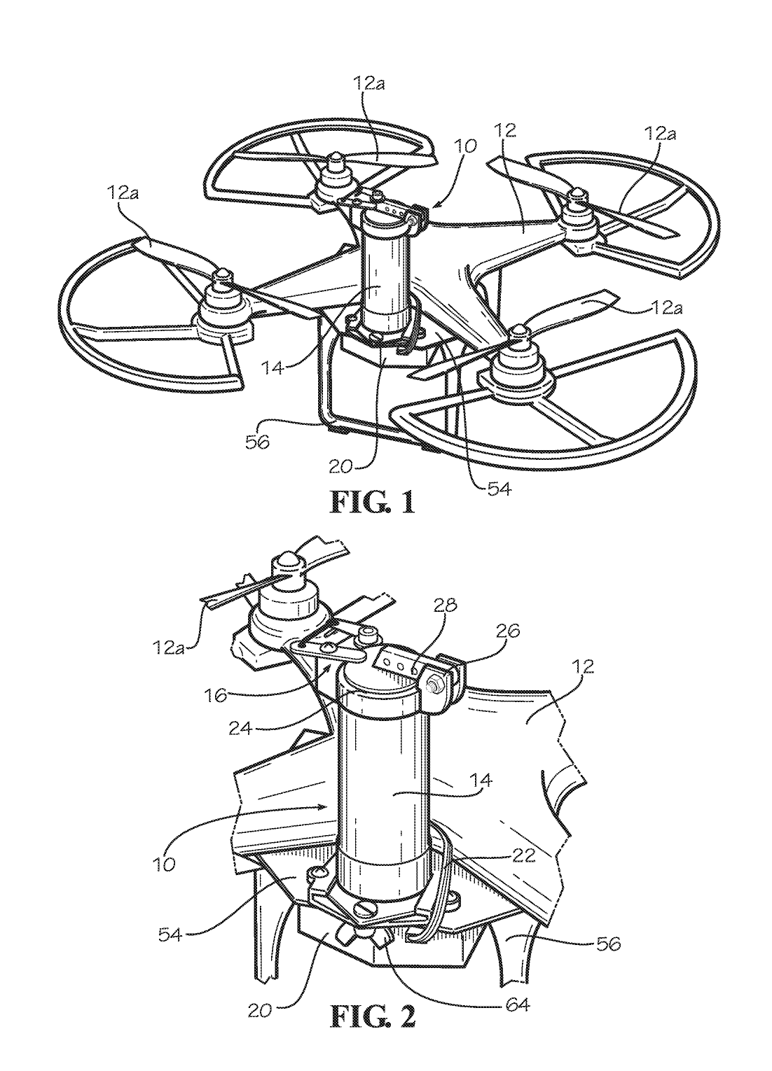

Referring to FIGS. 1 and 2, an embodiment for a safety and recovery system 10 for an unmanned aerial vehicle is shown attached to one type of aerial vehicle 12. An unmanned aerial vehicle 12 can be any vehicle capable of flight which is controlled without a pilot being positioned within aerial vehicle 12. Some examples of unmanned aerial vehicles include, but are not limited to, drones or multi-copters 12 which include multiple propellers which can be rotated to produce lift. The flight of drone or multi-copter 12 can be controlled remotely from the ground. In some applications, aerial vehicles 12 can be used for recreational purposes. In other applications, aerial vehicles 12 can be used for commercial or military purposes. In some instances aerial vehicles 12 can be equipped with camera or recording equipment in order to perform certain tasks including but not limited to commercial landscape surveying or military reconnaissance.

In some embodiments, as shown in FIGS. 2-5, safety and recovery system 10 can include a parachute holder 14 which is mountable to aerial vehicle 12. A parachute 18 can be disposed in parachute holder 14. Parachute holder 14 is shown as a canister in FIGS. 2-5. In other embodiments, parachute holder 14 can be any suitable structure capable of selectively holding a parachute before deployment, including but not limited to, a container, box, bag, strap assembly, hook, clip, hook and loop assembly, or other suitable retention device. An actuator 16 can be engaged with parachute canister 14. Actuator 16 can be configured or oriented to selectively release parachute 18 from parachute canister 14. A flight sensor 20 can be in communication with actuator 16. Being “in communication with” another object can mean that the two objects are electrically wired together, or that the two objects can communicate via wireless telemetry including a radio frequency transmitter and receiver. In some embodiments, actuator 16 can be in communication with flight sensor 20 via actuator wire 22. Flight sensor 20 can be programmed to detect one or more predetermined emergency flight conditions of aerial vehicle 12. Flight sensor 20 can produce and transmit an emergency signal to actuator 16 when flight sensor 20 detects one or more predetermined emergency flight conditions. Actuator 16 can deploy parachute 18 from parachute canister 14 in response to the emergency signal of flight sensor 20 when actuator 16 receives the emergency signal. As such, when flight sensor 20 determines that aerial vehicle 12 is in an emergency condition, flight sensor 20 can signal or instruct actuator 16 to deploy or release parachute 18 and potentially help slow aerial vehicle's 12 decent and help prevent damage to vehicle 12 as aerial vehicle 12 hits the ground.

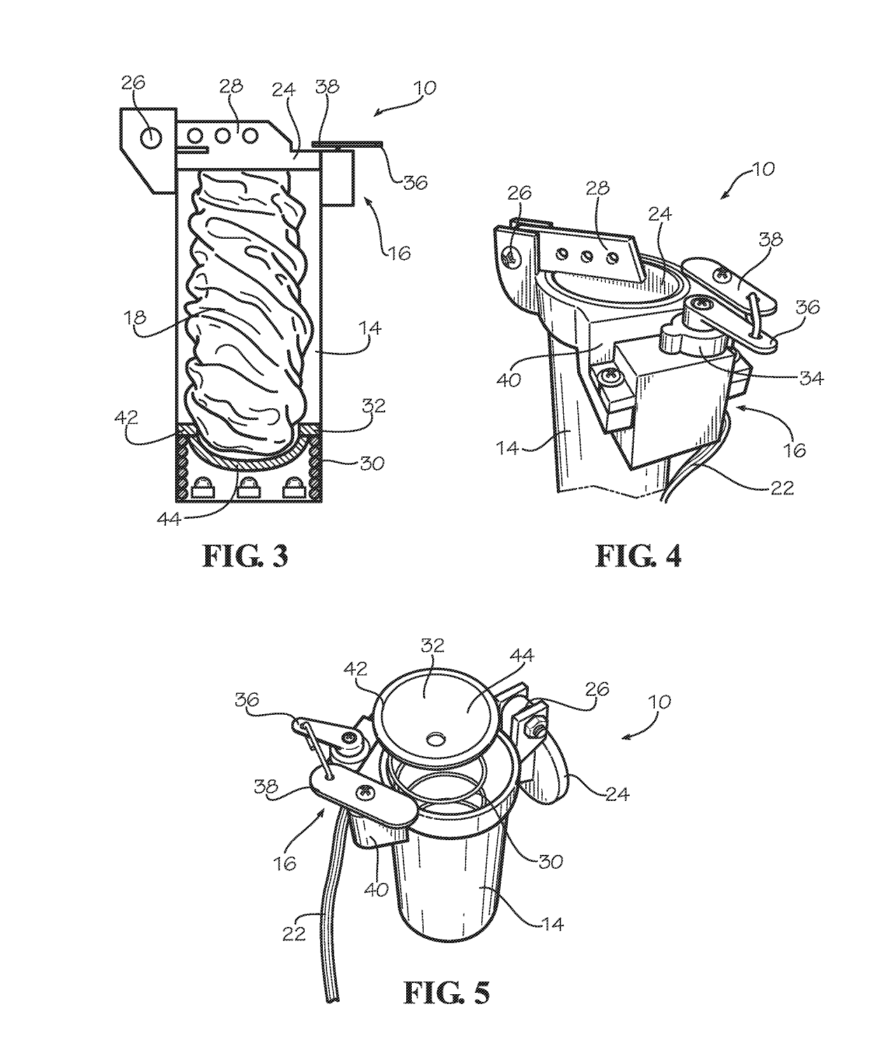

In some embodiments, parachute canister 14 can include a cover 24 movable between an open position, shown in FIG. 5, and a closed position, shown in FIG. 2. In some embodiments, cover 24 can be pivotally connected to canister 14 by hinge 26. Cover arm 28 can be mounted to cover 24 and pivotally connected to hinge 26. Parachute 18 can be deployably disposed in parachute canister 14, as shown in FIG. 3. In some embodiments, parachute 18 can be deployable out of parachute canister 14 as cover 24 moves from the closed position to the open position.

In some embodiments, parachute 18 can be biased to deploy out of parachute canister 14 as cover 24 moves from the closed position to the open position. Actuator 16 can include a spring 30 disposed in parachute canister 14, parachute 18 positioned between spring 30 and cover 24, and a buffer plate 32 positioned between spring 30 and parachute 18 when cover 24 is in the closed position. As such, spring 30 can be compressed by the parachute 18 via buffer plate 32 when cover 24 is in the closed position such that spring 30 is loaded or biased, spring 30 having potential energy which can bias parachute 18 out of parachute canister 14 when cover 24 moves to the open position. As cover 24 moves to the open position, the potential energy in spring 30 can force or bias buffer plate 32 and therefore parachute 18 upward and out of parachute canister 14, such that parachute 18 can be deployed from parachute canister 14. In such embodiments, actuator 16 deploying parachute 18 can allow cover 24 to move to the open position so that parachute can be forced or deployed out of parachute canister 14 via spring 30.

In some embodiments, buffer plate 32 can be shaped to at least partially extend into spring 30 when spring 30 is compressed by parachute 18 and cover 24 is in the closed position. In such embodiments, buffer plate 32 can include an outer rim 42 resting on spring 30, and a central portion 44 that extends downward into compressed spring 30. In some embodiments, central portion 44 can have a rounded, semi-spherical, rectangular, conical, pyramidal or other suitable shape that can extend downward into spring 30. Having a portion of buffer plate 32 extending into spring 30 can help maximize the amount of storage space within parachute canister 14 such that the size of a parachute 18 capable of being stored in parachute canister 14 can be increased. A larger parachute 18 can help produce an even larger resistance force to the downward motion of an aerial vehicle during free fall, which can help further slow the decent of an aerial vehicle when parachute 18 is deployed.

Actuator 16 can be oriented to selectively engage cover 24, such that actuator 16 is oriented to retain cover 24 in the closed position when actuator 16 engages cover 24. In some embodiments, actuator 16 can be motorized and can include a rotational servo motor 34 with a servo arm 36 that can be rotated to cause actuator 16 to engage cover 24. In some embodiments, servo arm 36 can engage cover 24 directly. In other embodiments, servo arm 36 can be coupled or linked to a secondary arm 38. Servo arm 36 can effectively rotate secondary arm 38 such that secondary arm 38 can selectively engage and disengage cover 24, as shown in FIGS. 2-5. Secondary arm 38 can be pivotally connected to parachute canister 14 and servo arm 36 can be coupled to an end of secondary arm 38, such that as servo arm 36 rotates on servo motor 34, servo arm 36 rotates secondary arm 38 about its pivot point on parachute canister 14. As secondary arm 38 rotates, a portion of secondary arm 38 can be positioned over cover 24 such that secondary arm 38 retains cover 24 in the closed position or prevents cover 24 from moving to the open position. In other embodiments actuator 16 can be a linear actuator including an actuator arm that moves linearly with respect to actuator 16 and can selectively extend from the actuator over cover 24 to retain cover 24 in the closed position.

In some embodiments, flight sensor 20 can include one or more depressible buttons which can be used to manually set or program the positions of servo arm 36 corresponding to the open and closed positions of cover 24. For example, servo arm 36 could be manually placed in an engaged or closed position with cover 24, and a closed position button can be depressed so that flight sensor 20 and servo motor 34 can be set or programmed to recognize that position as the closed position for servo arm 36. Similarly, servo arm 36 can be manually moved to a disengaged or open position with cover 24 and an open position button on flight sensor 20 can be pressed to set or program flight sensor 20 and servo motor 34 to recognize that position of servo arm 36 as the open position. As such, during flight when an emergency condition arises, servo motor 34 and flight sensor 20 can be programmed to move servo arm 36 from the closed position to the open position to release cover 24 and deploy parachute 18 In other embodiments, flight sensor 20 and servo motor 34 can be pre-programmed with proprietary software which recognizes the open and closed positions of servo arm 36.

During flight of an aerial vehicle, when flight sensor 20 detects one of the predetermined emergency conditions and transmits the emergency signal, flight sensor 20 can instruct actuator 16 via the emergency signal to actuate and rotate servo arm 36 and disengage secondary arm 38 from cover 24 such that spring 30 can force parachute 18 to move upward and move cover 24 from the closed position to the open position and effectively deploy parachute 18.

In some embodiments, parachute canister 14 can include an actuator platform 40. Actuator platform 40 can be located generally adjacent the top of parachute canister 14 near cover 24. Servo motor 34, servo arm 36, and secondary arm 38 of actuator 16 can be mounted to actuator platform 40. In some embodiments, cover 24 may also be pivotally connected to actuator platform 40 such that hinge 26 is located on actuator platform 40. In some embodiments, actuator platform 40 can generally be described as a ring which is mounted on an upper edge of parachute canister 14.

In other embodiments, parachute 18 can be deployed from parachute canister 14 by any suitable mechanism. For instance in some embodiments, actuator 16 can include a blast mechanism (not shown), which can be disposed in parachute canister 14 below buffer plate 32. A blast mechanism can be any suitable structure for producing a sudden upward force within parachute canister 14, the force deploying parachute 18 out of parachute canister 14. In some embodiments, the blast mechanism can include a pneumatic compressed gas supply, and the blast mechanism can selectively supply a burst of compressed gas into parachute canister 14. The burst of gas can force the parachute up and out of parachute canister 14. The burst of gas can also help expand parachute 18 more quickly as parachute 18 exits parachute canister 14. The emergency signal transmitted by flight sensor 20 when flight sensor 20 detects an emergency condition can trigger the blast mechanism which can force buffer plate 32 and thus parachute 18 up and out of parachute canister 14. In some embodiments, actuator 16 can also be engaged with cover 24 such that when an emergency condition is detected by flight sensor 20, flight sensor 20 can simultaneously open cover 24 via actuator 16 and trigger the blast mechanism to deploy parachute 18 out of parachute canister 14. In still other embodiments, cover 24 can be a breakaway cover detachably connected to parachute canister 14. The force from the blast mechanism can effectively break cover 24 away from parachute canister 14 and deploy parachute 18 out of parachute canister 14.

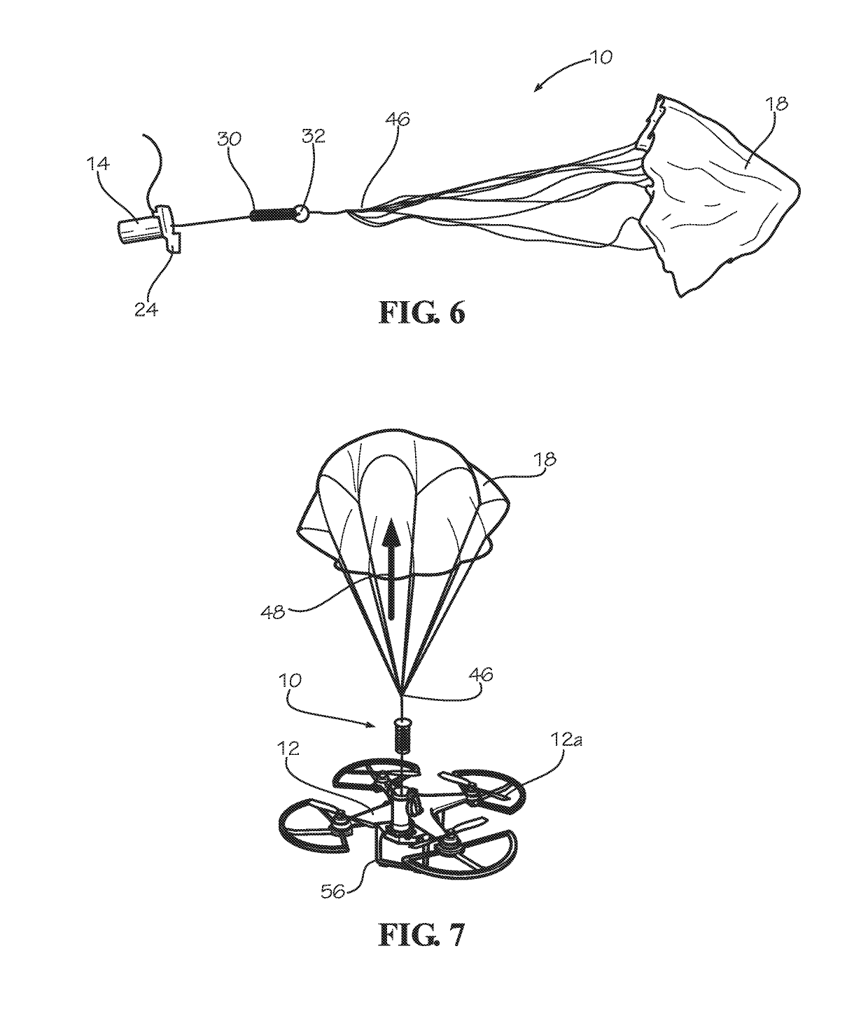

Parachute 18 can be connected to parachute canister 14 by a cord 46 shown in FIG. 6 such that when parachute 18 deploys, parachute 18 is opened as the falling aerial vehicle 12 and parachute canister 14 produces tension in cord 46, as shown in FIG. 7. In other embodiments, cord 46 could be connected to buffer plate 32 or spring 30. As parachute 18 opens, air resistance can exert an upward force 48 against parachute 18 as aerial vehicle 12 descends. Upward force 48 can slow the fall of aerial vehicle 12 significantly, such that aerial vehicle 12 can potentially fall to the ground at a reduced speed, resulting in the decrease of the potential for any damage to aerial vehicle 12 or any other equipment positioned on aerial vehicle 12.

Referring again to FIGS. 2-5, flight sensor 20 can be coupled or in communication with actuator 16. The flight sensor 20 can be programmed to detect a predetermined emergency condition in aerial vehicle 12 such as free falls, tumbles, flips, rolls, or any combination thereof, and in any number thereof. The exact parameters programmed into flight sensor 20 for detection of one or more predetermined emergency conditions can vary in different embodiments as the parameters used to detect a predetermined emergency condition can be tailored according to the particular aerial vehicle 12 for which safety and recovery system 10 is being used. The parameters used to detect the predetermined emergency flight conditions will be indicative of a particular aerial vehicle 12 being in an emergency state where proper flight is compromised.

For example, flight sensor 20 in some embodiments can include an altitude meter which could be used to monitor and determine a predetermined threshold decrease in altitude within a given time period which could indicate that aerial vehicle 12 was in free fall or otherwise in an emergency condition. In other embodiments, flight sensor 20 could include an accelerometer which could monitor the acceleration of aerial vehicle 12 and could be used to detect a predetermined downward or negative acceleration threshold of aerial vehicle 12, which could indicate that aerial vehicle 12 was in free fall or otherwise in an emergency condition. For instance, in some embodiments, an emergency condition can be detected by flight sensor 20 when the downward acceleration exceeds about seven meters per second squared. In other embodiments, an emergency condition can be detected by flight sensor 20 when the downward acceleration of aerial vehicle 12 exceeds about five meters per second squared.

In still other embodiments, flight sensor 20 can include a gyroscope which can monitor the orientation of aerial vehicle 12 with respect to a horizontal reference axis. If aerial vehicle 12 rotates past a predetermined angular threshold during flight, for instance 90 degrees in some embodiments, such that aerial vehicle 12 is effectively flying on its side, flight sensor 20 can be programmed to detect that such a state is an emergency condition. In some embodiments, flight sensor 20 can include both an accelerometer and a gyroscope to detect either a threshold acceleration and/or a threshold angular rotation indicative of an emergency condition. When flight sensor 20 detects one or more predetermined emergency conditions, flight sensor 20 can transmit an emergency signal to actuator 16 to deploy parachute 18 from parachute canister 14.

In some embodiments where flight sensor 20 can include multiple measurement tools, the flight sensor can include an algorithm which analyzes multiple flight parameters, including but not limited to the altitude, acceleration, and rotation or aerial vehicle 12, to determine when aerial vehicle 12 is in an emergency condition. In some embodiments, the algorithm can be calibrated with respect to the altitude of aerial vehicle 12, such that when aerial vehicle 12 is higher up the emergency condition thresholds can be larger as there is generally more time to recover from irregular flight the higher aerial vehicle 12 is. In some embodiments, flight sensor 20 can be equipped with a universal serial bus which can allow flight sensor 20 to be connected to or communicated with another computer, tablet, device, etc. in order for a user to modify or adjust the flight sensor 20. For instance, a universal serial bus can be used to install firmware or software updates, as well as change emergency condition parameter thresholds which can cause flight sensor 20 to trigger an emergency signal. For instance if the threshold acceleration was desired to be increased before flight sensor 20 recognize the emergency, the flight sensor 20 and associated logarithm for detecting an emergency system could be accessed and modified through the universal serial bus.

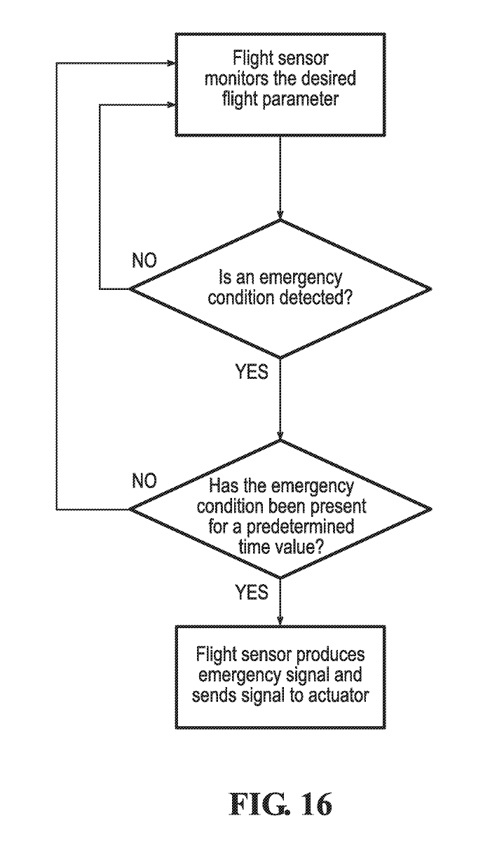

In some embodiments, the flight sensor 20 can be programmed to have a feedback verification system. The logic for one embodiment of a feedback verification system is diagrammed in FIG. 16. The feedback system begins by taking an initial measurement of the monitoring parameters (acceleration, rotation, etc.). If the measurements are below the predetermined thresholds then no action is taken and the system continues to monitor the flight parameters of the aerial vehicle. If the measurements are above a predetermined threshold, then an emergency condition is detected. The flight sensor then determines if the emergency condition has been present for a predetermined period of time.

In some embodiments, flight sensor can include a measurement counter, the measurement counter calculating the number of measurements taken since an initial emergency condition was indicated. The measurements can be taken at set intervals so the total time of the emergency condition can be calculated by multiplying the number of measurements by the measurement time interval. If the emergency condition has not been present for a predetermined time value, then the flight sensor proceeds to take an additional measurement to ensure the emergency condition is still present. If the emergency condition subsides on the next measurement, then the measurement counter can be automatically reset to zero, and the process starts over. If the emergency condition remains, the flight sensor again checks to see if the emergency condition has been present for a predetermined time value. This process is repeated until the emergency condition has been present for a predetermined time value, wherein the flight sensor is programmed to produce and transmit the emergency signal and instruct the actuator to deploy the parachute.

The predetermined time value can be varied in different embodiments. In some embodiments the predetermined time value can be about half a second. In other embodiments, the predetermined time value can be about one second. The predetermined time value can be inherently limited as there is a point after a given period of freefall where the aerial vehicle will reach the ground, and thus deployment of the parachute would be too late.

However, such a feedback verification system can help prevent the deployment of the parachute in situations where the aerial vehicle perhaps falters and then recovers on its own without the need for the parachute to deploy. An operator could also momentarily reduce the throttle on the aerial vehicle which could cause a momentary fall of the aerial vehicle. However, the operator could then increase the throttle to steady the aerial vehicle. Additionally, and particularly in recreational applications, the operator could intentionally cause the aerial vehicle to dive, flip or spin similarly to the flight in an emergency condition, though the aerial vehicle is not actually in an emergency condition. A feedback verification system as described above could help prevent the parachute from deploying in such circumstance when the aerial vehicle is not actually in a free fall or other emergency state. Additionally, a slight delay in the release of the parachute during freefall can help ensure that when the parachute is released the aerial vehicle is falling at a sufficient velocity to properly expand or deploy the parachute.

Additionally, in some embodiments, the flight sensor can include basic machine learning programming to help the flight sensor determine if the aerial vehicle is actually crashing. The flight sensor can use the machine learning capabilities to analyze and study normal flight patterns or characteristics in initial flights of the aerial vehicle. A controlled flip or roll will have different flight characteristics than an uncontrolled flip. For instance a controlled flip or roll may be faster or quicker than an uncontrolled flip or roll, as the operator is directing that motion The flight sensor can be programmed to refrain from producing an emergency signal during the first several flights, and monitor for controlled abnormalities in the flight pattern such as flips, rolls or dives, which may be intentionally performed by the operator, in order to compare such intentional abnormal flight patterns from similar unintentional abnormal flight patterns that are indicative of an emergency condition. The machine learning language can then be programmed to recognize the controlled flip or roll flight patterns as normal flight and not deploy the parachute system if those patterns are detected during flight of the aerial vehicle.

After a predetermined number of initial flights, the system will go fully active and release the parachute when the flight sensor detects an emergency condition. As such, the machine learning period for the flight sensor can help identify proper or acceptable flight patterns which may be similar to emergency conditions, which can help unwanted deployment of the parachute during such acceptable flight patterns. The machine learning period coupled with the feedback verification system, which can slightly delay deployment of the parachute in an emergency condition, can help prevent the flight sensor from errantly deploying during short trick maneuvers or short variances in normal flight pattern, where the aerial vehicle recovers shortly thereafter.

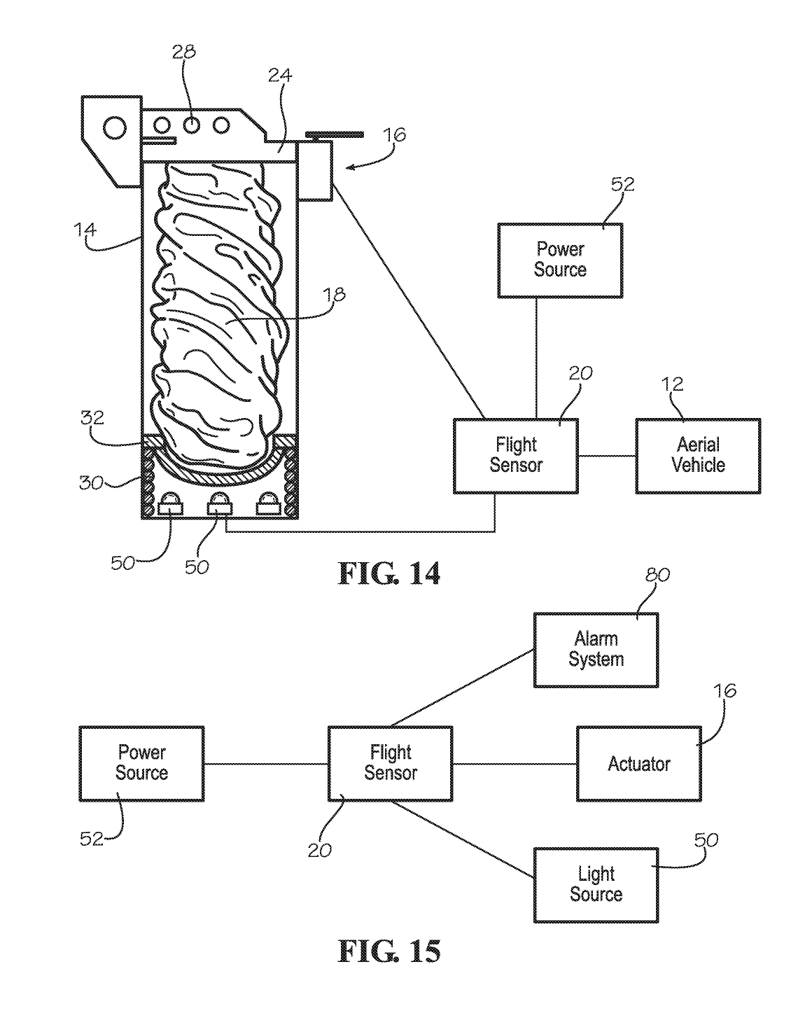

Referring now to FIGS. 14-15, in some embodiments, safety and recovery system 10 can include one or more color changing light sources 50 which can be used to indicate the status of aerial vehicle 12 as detected by flight sensor 20. Color changing light sources 50 can be in communication with flight sensor 20. Color changing light sources 50 can be programmed to change color as the status of aerial vehicle 12 changes. Color changing light sources can be any suitable light source, including but not limited to, fluorescent lamps, incandescent bulbs, light emitting diodes, halogen bulbs, etc. In some embodiments, color changing light sources 50 can be RGB LEDs that can selectively alternate between a red, green, and blue lighting profile. Each color can indicate a different status. For instance, color changing light sources 50 can be programmed to turn red when color changing light sources 50 receive an emergency signal from flight sensor 20 indicating that aerial vehicle 12 is in an emergency condition. Color changing light sources 50 can be programmed to turn green during normal flight conditions, and blue when there is a status update or modification being made to the system.

In some embodiments, color changing light sources 50 can be disposed directly on flight sensor 20. In other embodiments, parachute canister 14 can be made of a translucent or transparent material, and color changing light sources 50 can be disposed within parachute canister 14, as shown in FIG. 14. As such, color changing light sources 50 can illuminate the entire parachute canister 14 in the desired status color such that the status of aerial vehicle 12 can be more readily seen by an observer or operator on the ground. In some embodiments, color changing light sources 50 can be arranged in a ring underneath the parachute canister's 14 inner walls to turn the parachute canister 14 into a glowing light up canister.

In some embodiments, aerial vehicle can include its own primary power source such as a battery or other suitable power supply which can provide power to aerial vehicle 12 during normal flight operations. Safety and recovery system 10 can also include a separate independent secondary power source 52 such as a battery or other suitable power supply which can be electrically connected to flight sensor 20 as well as other powered components of actuator 16, such that if power to aerial vehicle 12 from its primary power source is disrupted, then safety and recovery system 10 could still be powered by secondary power source 52 to deploy parachute 18 in the event of an emergency. As such, secondary power source 52 and safety and recovery system 10 can operate independently or autonomously from aerial vehicle 12 and its primary power supply. In some embodiments, as flight sensor 20 detects an emergency condition and transmits an emergency signal to actuator 16, flight sensor 20 can also supply power from secondary power source 52 to actuator 16. In some embodiments, secondary power source 52 can be a rechargeable battery. In those embodiments that include a universal serial bus, secondary power source 52 can be electrically connected or communicated with the universal serial bus, such that secondary power source 52 can be recharged via the universal serial bus.

In some embodiments, flight sensor 20 can also be in communication with the aerial vehicle 12, and specifically the primary power source of aerial vehicle 12. As such, flight sensor 20 can monitor certain system parameters of aerial vehicle 12 to ensure that aerial vehicle 12 is in fact receiving power and detect a power failure in aerial vehicle 12. In the event that power to aerial vehicle 12 from its primary power supply is terminated, flight sensor 20 can be programmed to identify such a circumstance as an emergency condition and deploy parachute 18 via actuator 16. In some embodiments, flight sensor 20 can be in communication with aerial vehicle 12 via wireless telemetry to monitor the power supply to aerial vehicle 12. In other embodiments, flight sensor 20 can be electrically coupled to the primary power supply of aerial vehicle 12, such that safety and recovery system 10 primarily runs off of the power supply of aerial vehicle 12, and secondary power source 52 is a backup power supply. In the event that the primary power supply of aerial vehicle 12 malfunctions and ceases to supply power to flight sensor 20, then flight sensor 20 could be programmed to identify the lack of power from the primary power source of aerial vehicle 12 as an emergency condition, and flight sensor 20 could use secondary power source 52 to transmit an emergency signal to actuator 16 to deploy parachute 18.

In some embodiments where flight sensor 20 is in communication with aerial vehicle 12, in the event of an emergency flight sensor 20 could cut power to aerial vehicle 12 such that propellers 12a (shown in FIG. 7) on aerial vehicle 12 are shut off. When parachute 18 is deployed, having propellers 12a shut off can help reduce interference between propellers 12a and safety and recovery system 10, and particularly cord 46 of parachute 18. Cord 46 can become tangled with propellers 12a if propellers 12a are spinning during deployment of parachute 18, which can adversely affect or even prevent proper opening of parachute 18.

Flight sensor can also be programmed to include one or more bypasses which can prevent deployment of parachute 18 despite an emergency condition being present. For instance, if a flight sensor 20 was programmed to deploy when aerial vehicle 12 experienced a sustained rotation of more than 90 degrees, then when an operator turns over aerial vehicle 12, perhaps for maintenance or inspection prior to flight, then parachute 18 would deploy. The algorithm of flight sensor 20 in some embodiments, to help prevent such unwanted deployment, can include certain bypasses designed to prevent deployment even when emergency conditions may be present. Flight sensor 20 could be programmed to sense an initial power increase in aerial vehicle 12 to signal the beginning of a flight, parachute 18 not deploying any time before this initial power increase is detected. As such, if the operator is carrying or rotating aerial vehicle 12 prior to take off, parachute would not deploy despite the presence of what would otherwise be an emergency condition. Similarly, flight sensor 20 could be programmed to not deploy when an emergency condition was detected until a minimum height was detected by an altitude meter indicating the start of a flight for aerial vehicle 12.

Referring now to FIGS. 2, and 8-9, in some embodiments, system 10 can further include a base platform 54 mountable to aerial vehicle 12. Parachute canister 14 and flight sensor 20 can be mountable to base platform 54, such that parachute canister 14 and flight sensor 20 are mountable to aerial vehicle 12 via base platform 54. Many aerial vehicles 12 have one or more landing skids 56, or other landing gear which support aerial vehicle 12 while the vehicle is on the ground. In some embodiments, base platform 54 can be mountable on landing skids 56, or at the junction between landing skids 56 and a main body of aerial vehicle 12.

Base platform 54 can include one or more aerial vehicle mounting holes 57 which can correspond to prefabricated landing skid mounting holes on aerial vehicle 12 when base platform 54 is mounted on aerial vehicle 12. As such, base platform 54 can be positioned between landing skids 56 and a main body of aerial vehicle 12, and landing skids 56 can be connected through base platform 54 and to the main body of aerial vehicle 12, thereby mounting base platform 54 to aerial vehicle 12 between the main body and landing skids 56. In some embodiments, base platform 54 can be mounted across adjacent landing skids 56 such that base platform 54 can provide a relatively horizontal or level surface on which parachute canister 14 and flight sensor 20 can be mounted. Flight sensor 20 can be mounted below base platform 54 and parachute canister 14 can be mounted above base platform 54 in some embodiments. Base platform 54 and parachute canister 14 can be mounted on aerial vehicle 12 such that parachute canister 14 does not interfere or impede with the rotation of propellers 12a of aerial vehicle 12.

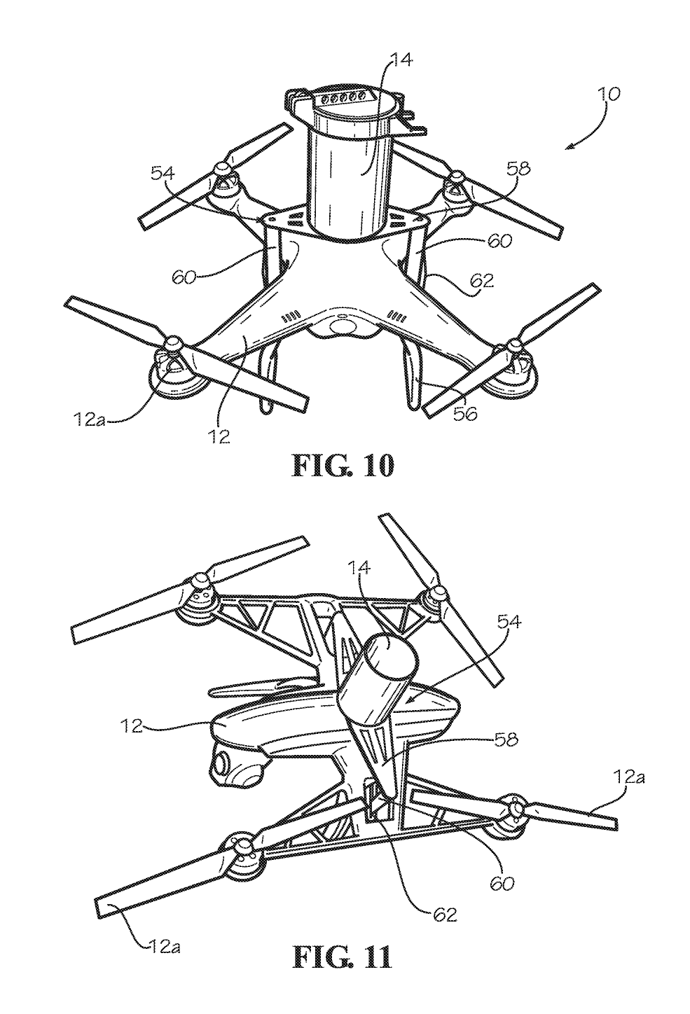

In some embodiments, as shown in FIGS. 10-12, base platform 54 can include a main base plate 58 positioned above a main body of aerial vehicle 12, and two extension rods 60 extending from main plate 58. Each extension rod 60 can be coupled to a connection member 62, connection members 62 connected or mounted on a corresponding landing skid 26 on opposing sides of the main body of aerial vehicle 12. As such, extension rods 60 allow main plate 58 of base platform 54 to be positioned above a main body of aerial vehicle 12 in a substantially horizontal orientation such that main plate 58 and parachute canister 14 mounted on main plate 58 can potentially be positioned over a central portion of aerial vehicle 12. As such, when a parachute is deployed from parachute canister 14, the parachute can apply an upward force on a generally central portion of aerial vehicle 12. Thus, aerial vehicle 12 can potentially descend in a balanced fashion and can potentially land on the ground in a substantially horizontal orientation on landing skids 56, as opposed to landing in a tilted orientation when base platform 54 is positioned in an acentric orientation on aerial vehicle 12.

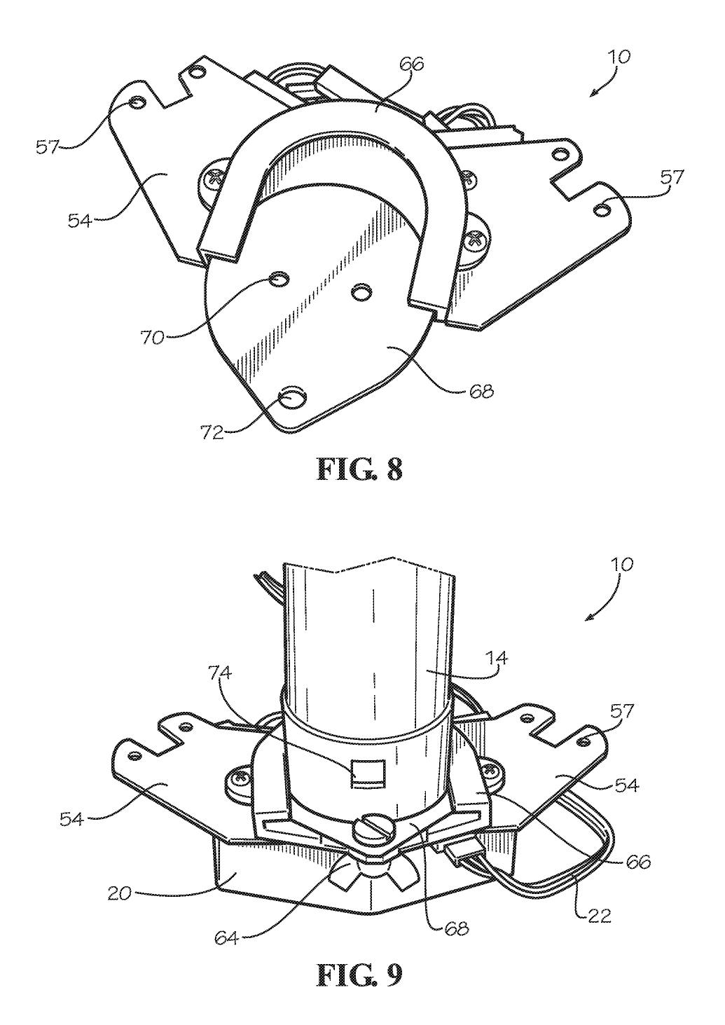

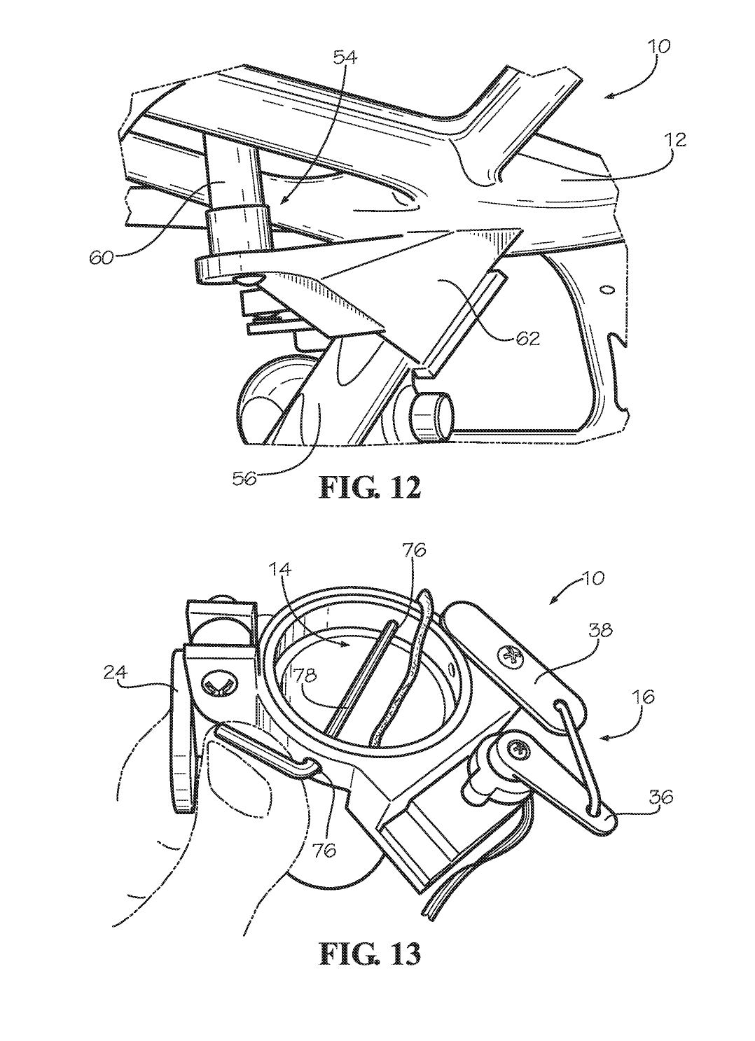

In some embodiments, each connection member 62 can be a connection plate similar to the base platform 54 shown in FIGS. 8-9 that can be connected between a landing skid 56 and a main body of aerial vehicle 12. In other embodiments, each connection member 62 can be a customized clamp that is connectable directly on a respective landing skid 56 as shown in FIG. 12.

In some embodiments, as shown in FIGS. 10-11, parachute canister 14 can be fixedly mounted or integrally formed on base platform 54. In other embodiments, as shown in FIGS. 8-9, parachute canister 14 can be detachably mounted to base platform 54. In some embodiments where parachute canister 14 is detachably mounted to base platform 54, base platform 54 can include a quick disconnect member 64 for detachably or selectively mounting parachute canister 14 onto base platform 54. Quick disconnect member 64 can help parachute canister 14 be quickly disconnected or demounted from base platform 54 and an aerial vehicle in order to reload a parachute into parachute canister 14 after deployment.

In FIGS. 8-9, canister 14 is shown as being slidably engaged with base platform 54. Base platform 54 can include a u-shaped retention member 66 extending upward from base platform 54. System 10 can include a bottom plate 68 which can be attached to parachute canister 14 via canister attachment holes 70. Bottom plate 68 when attached to parachute canister 14 can slide under retention member 66 such that retention member 66 helps prevent bottom plate 68 and parachute canister 14 from moving away from or tilting on base platform 54. Bottom plate 68 can also include a quick disconnect hole 72 which can align with a corresponding hole in base platform 54 when bottom plate 68 is received under retention member 66. A quick disconnect member 64 such as a bolt and wing nut as shown in FIG. 9 can be used to detachably mount bottom plate 68 and parachute canister 14 to base platform 54 via quick disconnect hole 72. To remove parachute canister 14 from base platform 54 after deployment of a parachute from parachute canister 14, the wing nut can be removed from the bolt of quick disconnect member 64, the bolt removed from quick disconnect hole 72, and parachute canister 14 and bottom plate 68 can slide out from retention member 66.

In other embodiments, quick disconnect member 64 can be any suitable structure for selectively and detachably mounting canister 14 onto base platform 54. In one embodiment, a bottom portion of parachute canister 14 can include a first set of screw threads, and a corresponding set of screw threads can be defined on base platform 54. As such, parachute canister 14 can be screwed down onto base platform 54 to detachably secure parachute canister 14 to base platform 54. Other suitable quick disconnect structures can include twist locking structures, hook and loop fasteners, detachable or removable adhesives, snap locking members, etc. In still other embodiments, parachute canister 14 can be directly mounted on an aerial vehicle via a removable adhesive such that it is not necessary to manufacture and attach a custom base platform 54 to the aerial vehicle to mount parachute canister 14 on the base platform 54.

Referring now to FIG. 9, in some embodiments, parachute canister 14 can further include one or more apertures 74 defined in an end of parachute canister 14, in some embodiments on a lower end of parachute canister 14 when parachute canister 14 is mounted on an aerial vehicle. Apertures can be machined or drilled into the sidewalls of canister 14. Apertures 74 can allow air to enter into parachute canister 14 during deployment of a parachute, the air helping to deploy and expand the parachute more quickly. In some embodiments, parachute canister 14 can include four equally spaced apertures 14 defined in a lower end of parachute canister 14 which can help provide uniform air flow through parachute canister 14 during deployment of the parachute.

Referring now to FIG. 13, in some embodiments, parachute canister 14 can include one or more retention rod holes 76 defined in an upper end of parachute canister 14 when parachute canister 14 is mounted to an aerial vehicle. Retention rod holes 76 can be sized to receive a retention rod such as a hex wrench or other suitable retention rod 78. Extension rod 78 can span parachute canister 14 when inserted through retention rod holes 76. As such, in embodiments where a parachute is biased to deploy out of parachute canister 14 when the parachute is loaded into parachute canister 14, retention rod 78 can be inserted through retention rod holes 76 once the parachute is loaded into parachute canister 14. Retention rod 78 can retain the parachute within parachute canister 14 and keep the parachute in a loaded state. Cover 24 can then be moved to the closed position and actuator 16 can be engaged with cover 24 to retain the parachute in parachute canister 14. Once the parachute of system 10 is loaded and actuator 16 is engaged with cover 24, retention rod 78 can be removed.

Referring now to FIG. 15, in some embodiments flight sensor 20 can also be in communication with an audible alarm system 80. When flight sensor 20 detects an emergency condition and produces an emergency signal, flight sensor 20 can transmit the emergency signal to audible alarm system 80 as well as provide power via power source 52 to audible alarm system 80, such that audible alarm system produces an audible sound which can alert the operator of the emergency condition. In some embodiments, alarm system 80 can include a siren and a speaker system for transmitting the audible alert sound via the siren. As such, in some embodiments, flight sensor 20 can simultaneously be in communication with actuator 16, color changing light source 50, and alarm system 80. When flight sensor 20 detects the emergency condition, the emergency signal can be transmitted to all three of actuator 16, color changing light source 50, and alarm system 80, such that actuator 16 deploys a parachute from the parachute canister, and color changing light source 50 and alarm system 80 produce a visual and audible alert respectively to alert the operator of the emergency condition in the event that the parachute fails to deploy properly. In still other embodiments, audible alarm system 80 can be actuated prior to deployment of the parachute so the alarm system 80 can potentially warn an operator of imminent deployment and allow the operator to correct the irregular flight pattern before the parachute deploys.

Similarly, in some embodiments, flight sensor 20 can be in communication with a remote control for an aerial device. When an emergency condition is detected by flight sensor 20, flight sensor 20 can send a warning signal to the remote control for the aerial device to warn the operator of an imminent parachute deployment in order to give the operator an opportunity to correct or recover from the irregular flight pattern and avoid parachute deployment. In some embodiments, flight sensor 20 can light up a warning light on the remote or sound a warning siren located on the remote.

There are several advantages to the various autonomous systems described herein. One advantage of an autonomous safety system can be the ability for the safety and recovery system to deploy the parachute when necessary autonomously and without the need for a user transmitted input signal. However, some embodiments can include a backup user input actuation including a radio frequency transmitter on a remote control for an aerial vehicle which can be in communication with system 10 and actuator 16. As such, if the parachute system 10 somehow fails to deploy autonomously, an operator can still potentially deploy the parachute via a manual actuation input.

An aerial vehicle that flies out of range with a system requiring user input to deploy a parachute can potentially fail, since it is unlikely that the user input will properly deploy the parachute if the aerial vehicle and the parachute system are out of range of the transmitter for the operator's manual input.

Because safety system 10 of the present disclosure is not dependent on a user transmitted signal or input to deploy its parachute, if an aerial vehicle flies out of radio range of the operator, the parachute still could deploy once the aerial vehicle runs out of power or flight sensor otherwise detects that the aerial vehicle is in an emergency condition.

Furthermore, the safety system of the present disclosure can also potentially have a quicker deployment time once an emergency condition occurs. In conventional solutions, where a user actuates the deployment of the parachute, deployment is entirely dependent on the user recognizing the emergency condition and actuating the parachute. If the user is not fast enough to visually detect an in-flight emergency, and subsequently actuate the transmitter to deploy a parachute, the aerial vehicle will most likely be damaged. The flight sensor of the present disclosure can, in some embodiments, detect an in-flight emergency almost immediately when the emergency condition arises, and subsequently deploy a parachute in a relatively small amount of time, thereby greatly improving the chances of a successful recovery at low altitude where every second is valuable. This invention can also help reduce or prevent injuries caused by free falling aerial vehicles striking bystanders.

Thus, although there have been described particular embodiments of the present invention of a new and useful Autonomous Safety And Recovery System For Unmanned Aerial Vehicles, it is not intended that such references be construed as limitations upon the scope of this invention.

What is claimed is:

1. A safety and recovery system for an unmanned aerial vehicle comprising:
a parachute holder mountable to the aerial vehicle;
a parachute disposed in the parachute holder;
an actuator engaged with the parachute holder;
a flight sensor in communication with the actuator, the flight sensor programmed to detect one or more predetermined emergency flight conditions, and transmit an emergency signal when the flight sensor detects one of the predetermined emergency flight conditions;
wherein the actuator deploys the parachute from the parachute holder when the actuator receives the emergency signal from the flight sensor.

2. The system of claim 1, further comprising a base platform mountable to the aerial vehicle, the parachute holder and the flight sensor mountable to the base platform such that the parachute holder and the flight sensor are mountable to the aerial vehicle via the base platform.

3. The system of claim 2, wherein the base platform includes a quick disconnect member for selectively mounting the parachute holder to the base platform.

4. The system of claim 2, wherein the parachute holder is slidably engaged with the base platform.

5. The apparatus of claim 2, wherein the aerial vehicle includes one or more landing skids, and the base platform is coupled to the one or more landing skids.

6. The system of claim 1, wherein the flight sensor further comprises an accelerometer programmed to detect downward acceleration of the aerial vehicle.

7. The system of claim 1, wherein the flight sensor further comprises a gyroscope programmed to detect relative rotation of the aerial vehicle.

8. The system of claim 1, wherein the flight sensor further comprises an altitude meter programmed to detect an altitude of the aerial vehicle above ground.

9. The system of claim 1, wherein the aerial vehicle further comprises a primary power source, and the system further comprises a separate independent secondary power source electrically connected to the flight sensor.

10. The system of claim 1, further comprising one or more color changing light sources in communication with the flight sensor, the one or more color changing light sources programmed to change color when the one or more color changing light sources receive the emergency signal from the flight sensor.

11. The system of claim 10, wherein:
the parachute holder is a parachute canister made of a translucent material; and
the one or more color changing light sources are disposed in the parachute canister such that one or more color changing light sources selectively illuminate the parachute canister.

12. The system of claim 1, further comprising an audible alarm system in communication with the flight sensor, the audible alarm system programmed to produce an audible alert sound when the audible alarm system receives the emergency signal from the flight sensor.

13. A safety and recovery system for an unmanned aerial vehicle comprising:
a parachute canister mountable to the aerial vehicle, the parachute canister including a cover movable between an open position and a closed position;
a parachute disposed in the parachute canister when the cover is in the closed position, the parachute biased to deploy out of the parachute canister as the cover moves from the closed position to the open position;
an actuator selectively engaged with the cover, the actuator oriented to retain the cover in the closed position when the actuator is engaged with the cover; and
a flight sensor in communication with the actuator, the flight sensor programmed to detect one or more predetermined emergency flight conditions, and transmit an emergency signal when the flight sensor detects one of the predetermined emergency flight conditions;
wherein when the actuator receives the emergency signal from the flight sensor, the actuator disengages with the cover such that the cover is allowed to move to the open position and the parachute is deployed from the parachute canister.

14. The apparatus of claim 13, further comprising a spring disposed in the parachute canister, the parachute positioned between the spring and the cover when the cover is in the closed position, the spring deploying the parachute out of the parachute canister when the cover moves to the open position.

15. The apparatus of claim 14, further comprising a buffer plate positioned between the spring and the parachute when the parachute is disposed in the parachute canister and the cover is in the closed position.

16. The apparatus of claim 15, wherein the buffer plate is shaped to at least partially extend into the spring when the parachute is disposed in the parachute canister and the cover is in the closed position.

17. The apparatus of claim 13, wherein the parachute canister further comprises one or more retention rod receiver holes defined in an upper end of the parachute canister when the canister is mounted to the aerial vehicle.

18. A safety and recovery system for an unmanned aerial vehicle comprising:
a parachute canister mountable to the aerial vehicle, the parachute canister including a cover movable between an open position and a closed position;
a parachute disposed in the parachute canister when the cover is in the closed position, the parachute deployable out of the parachute canister when the cover moves from the closed position to the open position;
an actuator selectively engaged with the cover, the actuator oriented to retain the cover in the closed position when the actuator is engaged with the cover; and
a flight sensor in communication with the actuator, the flight sensor programmed to detect one or more predetermined emergency flight conditions, and transmit an emergency signal when the flight sensor detects one of the predetermined emergency flight conditions;
wherein when the actuator receives the emergency signal from the flight sensor, the actuator disengages with the cover such that the cover is allowed to move to the open position and the parachute is deployable from the parachute canister.

19. The system of claim 18, wherein the actuator is motorized.

20. The system of claim 18, wherein the aerial vehicle includes a primary power source, and the flight sensor is in communication with the aerial vehicle such that the flight sensor can detect a power failure in the primary power source of the aerial vehicle.
